(19) United States
(12) Patent Application Publication
(10) Pub. No.: US 2025/0153372 A1
(43) Pub. Date: May 15, 2025

(54) MULTI-BLADE FOOD SLICER

(71) Applicant: Yum Connect, LLC, Louisville, KY (US)

(72) Inventors: Maxwell Stephen Zoeller, Plano, TX (US); Andrew Charles Schonborn, Plano, TX (US); Aaron Bela Hedi, Plano, TX (US); Madeline Shelman, Plano, TX (US); Adam Afzali, Duxbury, MA (US); Mery Lee Cordero Pabon, Orlando, FL (US); Anna Scurti, Plano, TX (US); Matthew Eric Rosenthal, Plano, TX (US); Eric Patrick Lanoue, Plano, TX (US); Phillip James Veldwyk, Plano, TX (US); Justin Kristofer Tallio, Dallas, TX (US); Ishan Singh Mann, Irvine, CA (US)

(73) Assignee: Yum Connect, LLC, Louisville, KY (US)

(21) Appl. No.: 18/944,847

(22) Filed: Nov. 12, 2024

Related U.S. Application Data
(60) Provisional application No. 63/598,395, filed on Nov. 13, 2023.

(51) Int. Cl. B26B 3/04

(52) U.S. Cl. CPC B26B 3/04

(57) ABSTRACT

A multi-blade food slicer is provided. The multi-blade food slicer includes a frame having an upper side, a lower side, a front, and a back. The multi-blade food slicer includes a plurality of blades coupled to the lower side of the frame, including a first blade extending along a middle of the frame from at or near the front to the back, a second blade angularly disposed relative to the first blade and extending along the frame from at or near the front to the back on a left side of the frame, and a third blade angularly disposed relative to the first blade and extending along the frame from at or near the front to the back on a right side of the frame.

### CROSS-REFERENCE TO RELATED APPLICATION

This application claims the benefit of and priority to U.S. Provisional Application No. 63/598,395, filed on Nov. 13, 2023, which is incorporated herein by reference in its entirety and for all purposes.

### TECHNICAL FIELD

The present disclosure relates generally to food preparation devices and utensils and, more particularly, to a cutter or cutting tool.

### BACKGROUND

Food may be prepared using various systems and techniques. Certain foods may be cut or sliced for various reasons such as to portion servings. Various equipment and utensils may be utilized for this purpose.

### SUMMARY

An embodiment of the present disclosure relates to a multi-blade food slicer. The multi-blade food slicer includes a frame having an upper side, a lower side, a front, and a back, and a plurality of blades coupled to the lower side of the frame. The plurality of blades includes a first blade extending along a middle of the frame from at or near the front to the back, a second blade angularly disposed relative to the first blade and extending along the frame from at or near the front to the back on a left side of the frame, and a third blade angularly disposed relative to the first blade and extending along the frame from at or near the front to the back on a right side of the frame.

Another embodiment of the present disclosure relates to a multi-blade food slicer. The multi-blade food slicer includes a frame having an upper side, a lower side, a front, and a back. The frame includes a first arm extending along a middle of the frame from at or near the front to the back of the frame, a second arm angularly disposed relative to the first arm and extending from at or near the front to the back on a left side of the frame, a third arm angularly disposed relative to the first arm and extending from at or near the front to the back on a right side of the frame. The multi-blade food slicer includes a plurality of blades. The plurality of blades includes a first blade coupled to the first arm on the lower side of the frame and extending from at or near the front to the back, a second blade coupled to the second arm on the lower side of the frame and extending from at or near the front to the back, and a third blade coupled to the third arm on the lower side of the frame and extending from at or near the front to the back. The multi-blade food slicer includes a cross-member extending across the front of the frame and connected to the first, second, and third arms, and a handle coupled to the upper side of the frame on the first arm.

Still another embodiment of the present disclosure relates to a multi-blade food slicer. The multi-blade food slicer includes a top portion having a first blade and a second blade angularly disposed relative to the first blade. The multi-blade food slicer a bottom portion rotatably coupled to the top portion, wherein the top portion is movable from a closed position to an open position whereby the top portion is positioned a relatively greater distance away from the bottom portion in the open position than in the closed position. The bottom portion includes a first recessed guide structured to at least partly receive the first blade when the top portion and the bottom portion are in the closed position and a second recessed guide angularly disposed relative to the first recessed guide. The second recessed guide structured to at least partly receive the second blade when the top portion and the bottom portion are in the closed position.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a perspective view of a multi-blade food slicer, according to an exemplary embodiment.

FIG. 2 is a bottom perspective view of the multi-blade food slicer of FIG. 1, according to an exemplary embodiment.

FIG. 3 is a top view of the multi-blade food slicer of FIG. 1, according to an exemplary embodiment.

FIG. 4 is a bottom view of the multi-blade food slicer of FIG. 1, according to an exemplary embodiment.

FIG. 5 is a front view of the multi-blade food slicer of FIG. 1, according to an exemplary embodiment.

FIG. 6 is a back view of the multi-blade food slicer of FIG. 1, according to an exemplary embodiment.

FIG. 7 is a top view of a food item, according to an exemplary embodiment.

FIG. 8 is a side view of the multi-blade food slicer of FIG. 1, according to an exemplary embodiment.

FIG. 9 is a side view of the multi-blade food slicer of FIG. 1 on a work space with the food item of FIG. 7, according to an exemplary embodiment.

FIG. 10 is a top view of the work space according to an exemplary embodiment.

FIG. 11 is a perspective view of the work space according to another embodiment of the present disclosure.

FIG. 12 is a diagram of the locations of serrations along the length of the blades according to an exemplary embodiment.

FIG. 13 is a side cut-away of a portion of the serrated blade of FIG. 12.

FIG. 14 is a perspective view of a multi-blade food slicer, according to another exemplary embodiment.

FIG. 15 is an exploded view of the multi-blade food slicer of FIG. 14, according to an exemplary embodiment.

FIG. 16 is a view of the multi-blade food slider of FIG. 14 in a closed position, according to an exemplary embodiment.

### DETAILED DESCRIPTION

It should be understood at the outset that, although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

While not limited to a particular food preparation environment, consistent food quality and presentation may be an important aspect in commercial or professional kitchens. When certain foods are cut or sliced, it may be desirable to separate or cut the food into roughly even proportions for serving or otherwise. For example, a round pizza may be cut into roughly even, generally triangular sections or slices. Often a circular wheeled blade or roller blade is mounted on a handle and the blade is rolled across the pizza numerous times starting at different points along the circumference of the pizza to slice the pizza into roughly even-sized slices. Alternatively, single bladed devices, such as arced rocker blade, may be used that has a single long blade that extends across the diameter of the pizza. The rocker blade device is pressed down and “rocked” back-and-forth to cut the pizza and then the pizza or rocker blade is rotated relative to the previous cut and further cuts are made until the pizza is desirably sectioned into slices.

Other food, including but not limited to round or semicircular quesadillas, may be cut or sliced using similar techniques. However, cutting such food in this manner using such devices may not result in consistent, uniformly sized pieces or slices. When a user subjectively guesses or estimates the locations for evenly cutting such food, frequently some of the cuts are made inaccurately, which results in the slices or pieces being differently sized. Further, making multiple cuts or strokes may be time consuming and require substantial effort on the part of the user. Instead of a single bladed device, the present disclosure provides a multi-blade cutter or slicer. Advantageously, the multi-blade cutter allows users to cut food in more consistent shapes relative to traditional single blade cutting devices, thereby providing a higher quality food presentation.

While the present disclosure may be described as used for cutting food, such as semicircular quesadillas, the present disclosure is not limited and may be used with any kind of food, or any other items or material that may be so cut or separated. As used herein the term “food” or “food item” may refer to any type of food that may be desirably cut or sliced.

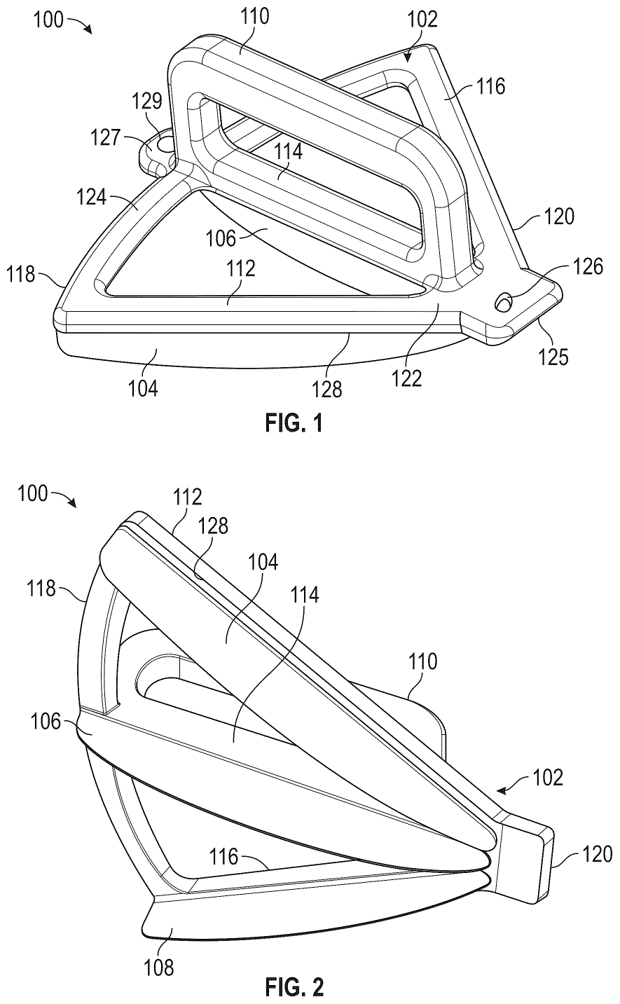

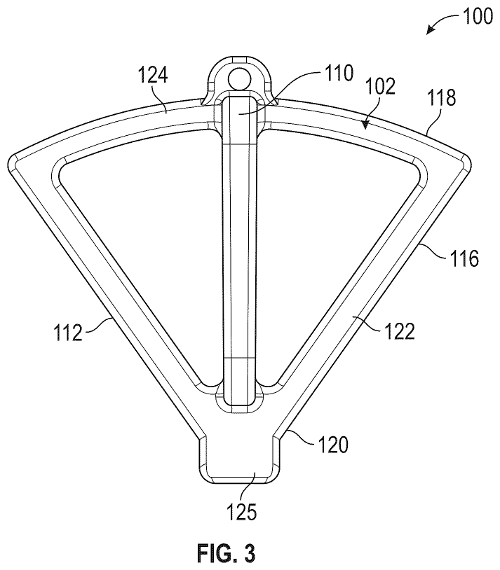

Referring now to FIGS. 1-3, the multi-blade food slicer, which may be referred to herein as a slicer 100, is shown, according to exemplary embodiments. The slicer 100 is shown to include a frame 102. A handle 110 is coupled to the frame 102 such that the handle 110 extends away from the frame 102. Multiple blades 104, 106, and 108 extend from the frame 102 on a side opposite the handle 110. In this embodiment, the slicer 100 is shown with three (3) blades 104, 106, and 108 which are used to slice a food product, and particularly, a semicircular food product (e.g., a quesadilla, a pie, a pizza, etc.) into four even sections. However, more or fewer blades 104, 106, and 108 may be used depending on the number of sections or portions into which the food is to be divided.

In the present embodiment, the frame 102 is shown having three support arms 112, 114, and 116, which may also be referred to as center support arm 114 and outer support arms 112, and 116, that generally extend from a front 118 to a back 120 on an upper side 122 of the frame 102. The frame 102 also includes a cross-member 124 that is connected to the support arms 112, 114, and 116 and extends across the front 118 of the frame 102. While the frame 102 is shown comprising separated support arms 112, 114, 116, and cross-member 124, in other embodiments, the frame 102 may instead be a substantially uniform, solid piece.

The handle 110 is connected to the center support arm 114. However, in other embodiments, the center support arm 114 and handle 110 may be integrated or uniformly constructed. While the handle 110 is shown, in this embodiment, as a “pull-type” design, the handle 110 may be otherwise configured in other embodiments. For example, the handle 110 may be rotated 90 degrees and be mounted to the outer support arms 112 and 116 and extend over the center support arm 114. Further, in other embodiments, two (2) separate handles 110 may be employed. In this case, one handle 110 may be placed near the front 118 of the frame 102 and another adjacent the back 120 of the frame 102. In still other embodiments, two (2) handles 110 may be provided, one on each of the outer support arms 112 and 116. In these embodiments, the handles may be configured as “pull-type” handles as shown, or “knob-type”, “post-type” or other known handle configurations. In still other embodiments, the handle 110 may be eliminated and the user may merely place a hand on the upper side 122 of the frame 102 to operate the slicer 100. These and other configurations are contemplated herein and are within the spirit and scope of the present disclosure.

The frame 102 also includes an extension component or tab 125 extending adjacent the back 120 of the frame 102. As will be further described, the tab 125 may be used to index or reference the starting location and position of the slicer 100 during operation. In some embodiments, the tab 125 may include an opening 126 or hole extending through the tab 125 which may be used to hang or hook the slicer 100 for storage when not in use. In some embodiments, a front extension 127 located and extending adjacent the front 118 of the frame 102 may be provided. In this embodiment, the front extension 127 includes a front opening 129 or hole extending through the front extension 127 and may similarly be used to hang or hook the slicer 100 for storage when not in use. In some embodiments, both, either, or neither of the front extension 127 and the tab 125, with or without the opening 126 and/or the front opening 129, may be implemented.

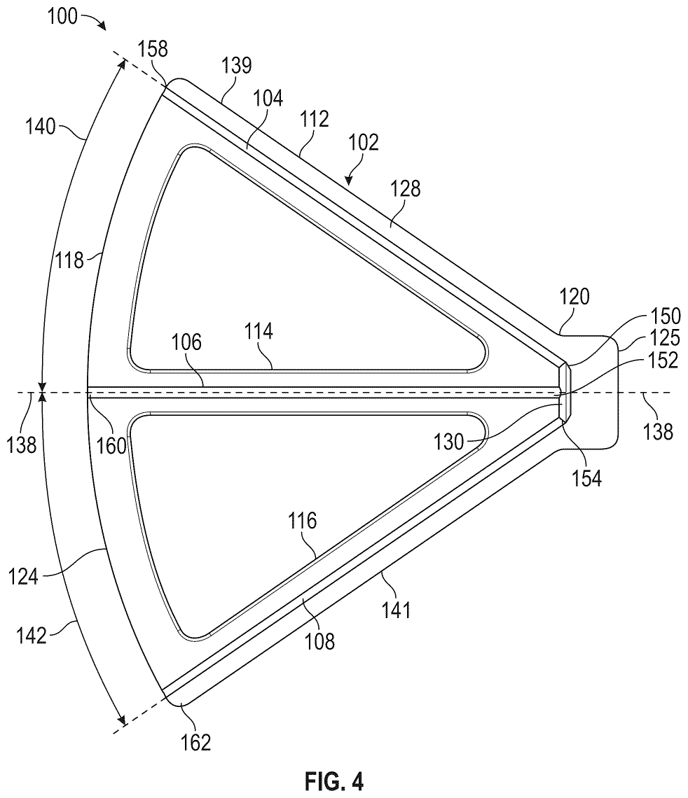

Referring also to FIG. 4, a bottom view of the slicer 100 is shown. The blades 104, 106, and 108, which may also be referred to as center blade 106 and outer blades 104 and 108, are mounted to and extend from a lower side 128 of the frame 102. The blades 104, 106, and 108 extend down, generally perpendicular to the lower side 128 of frame 102. The blades 104, 106, and 108 are elongated cutting blades that extend from adjacent the front 118 to adjacent the back 120 along the lower side 128 of the frame 102. In this view, the blades 104, 106, 108 are shown connected adjacent the back 120 of the frame 102 to a transverse member 130 situated substantially perpendicular to center blade 106. The transverse member 130 is a raised piece to further identify the start of the cut, as well as to provide a root for the blades 104, 106, and 108 to stem from geometrically. In addition, as the blades 104, 106, and 108 converge near the back ends 150, 152, and 154, small gaps or channels would otherwise exist, which can reduce cleanability. Thus, it may be desirable to provide sufficient spacing, as provided in the present embodiment, between the back ends 150, 152, 154 of blades 104, 106, and 108 to allow for cleanability of the slicer 100. In other embodiments, the transverse member 130 may not be employed.

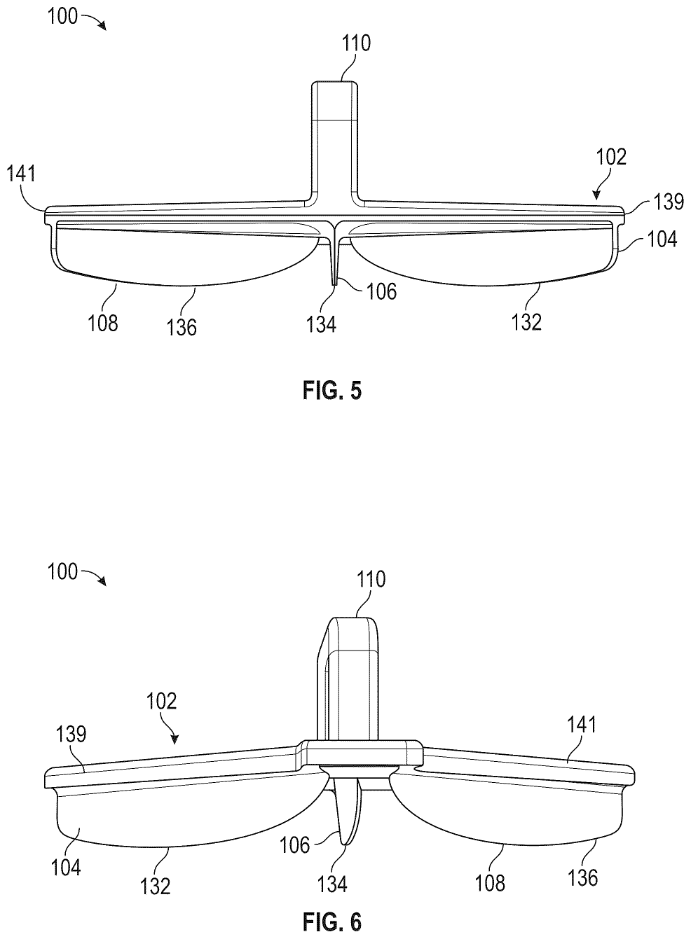

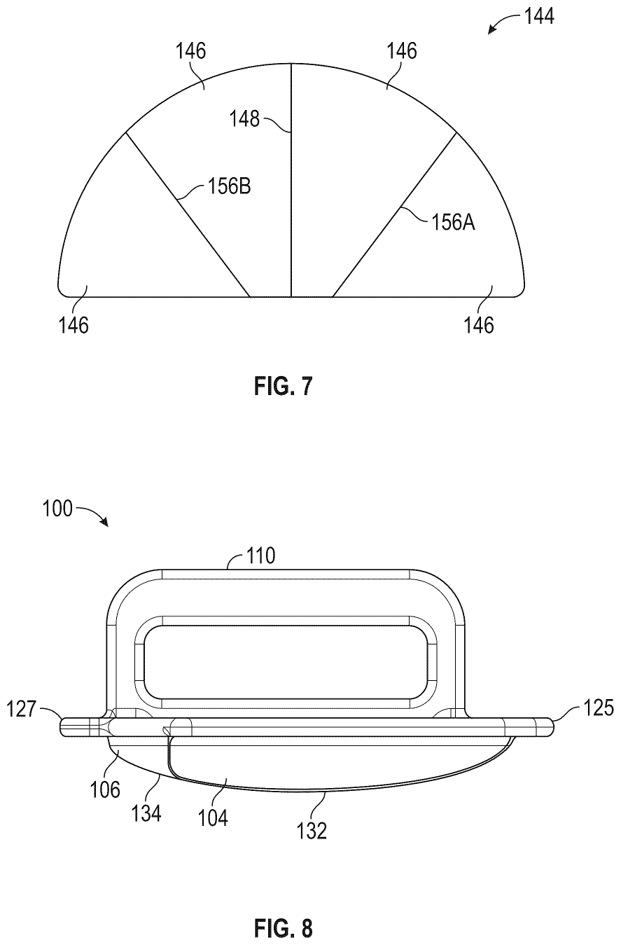

Referring also to FIGS. 5 and 6, lower edges 132, 134, 136 of blades 104, 106, and 108, respectively, are configured to provide a sharp cutting edge to cut the food into pieces. The overall length of the blades 104, 106, and 108, and slicer 100 generally, may be dictated by the overall size, shape, and dimensions of the food to be cut, as well as the angles, which are discussed below, at which the outer blades 104 and 108 are positioned. For example, referring also to FIG. 7, a food item 144, such as a semicircular quesadilla, is shown. The food item 144 is shown having a radius 148. Accordingly, the length of the blades 104, 106, and 108, would preferably be at least as long enough to completely traverse the radius 148 of the food item 144 in order to section the portions 146 of food to be cut by each of blades 104, 106, and 108. More detail about the food item 144 and lengths of blades 104, 106, and 108 are provided below.

Referring again to FIGS. 4, 5, and 6, as can be seen, center blade 106 extends along the lower side 128 of the frame 102 along generally the middle or a center line 138 of the slicer 100. The center line 138 is located generally equidistant between a left side 139 and a right side 141 of the frame 102. The outer blades 104 and 108 may be positioned at first and second angles 140 and 142, respectively, relative to the center line 138 or center blade 106 of about 25 to 45 degrees, or preferably about 30 to 40 degrees, or more preferably, in this embodiment, about 35 degrees. While the first and second angles 140 and 142 may be used in this embodiment, in other embodiments, the first and second angles 140 and 142 and other angles where more or fewer than three (3) blades are used may be chosen as desired depending on the size and shape the food stuff to be cut and the desired piece or portion sizes. Further, in still other embodiments, the angles of various blades may not be the same.

Referring again to FIG. 4, it can be seen that back ends 150, 152, and 154 of blades 104, 106, and 108, respectively, are offset and do not connect or abut one another, in this embodiment. As discussed above, providing sufficient space between the back ends 150, 152, 154 of blades 104, 106, and 108 allows for improved cleanability of the slicer 100. Referring again to FIG. 7, because the back ends 150, 152, and 154 of blades 104, 106, and 108 are offset, offset cuts 156A and 156B are necessarily shorter than the radius 148 of the food item 144. Thus, the center blade 106, which cuts along the radius 148 of the food item 144, may be longer than outer blades 104 and 108 (e.g., the length of the center blade 106 is greater than the lengths of the outer blades 104 and 106), which cut along the offset cuts 156A and 156B, respectively, or the outer blades 104 and 108 would not necessarily need to be as long as the center blade 106. Accordingly, in the present embodiment, the center blade 106 is longer than outer blades 104 and 108. For example, in an embodiment where the center blade 106 is about six (6) inches or so in length, the outer blades 104 and 108 may be about one (1) inch shorter or about five (5) inches or so in length. The outer blades 104 and 108 may have lengths that are approximately equal (e.g., the same). This design may provide a savings in materials, construction, and reduce the overall footprint or size of the slicer 100 while still providing sufficient length to completely cut through the food item 144 at the desired locations.

Also referring to FIG. 8, as can be seen, the blades 104, 106, 108 are curved along the lower edges 132, 134, 136. The curved lower edges 132, 134, and 136 allow for a rolling, rocking, and/or rotational movement of the slicer 100, between the back 120 and front 118, or vice-versa, of the frame 102, to execute the cutting operation. Referring also to FIG. 4, because the outer blades 104 and 108 are offset at the back ends 150 and 154 relative to the back end 152 of the center blade 106 and also because the angled disposition of the outer blades 104 and 108 relative to the center blade 106, the blades 104, 106, 108 have different curvatures along the lower edges 132, 134, 136 as they extend between the back ends 150, 152, and 154 to front ends 158, 160, and 162, respectively. For example, in this embodiment, the outer blades 104 and 108 have similar curvatures along the lower edges 132 and 136, while the center blade 106 may have a different curvature. The curved lower edges 132, 134, and 136 are shaped to allow for full contact of blades 104, 106, and 108 with the food item 144 throughout the full range of the rolling, rocking, cutting motion during operation. Again, it will be understood by one skilled in the art that these angles of the curvatures may differ depending on the size of the food item 144, number of portions 146 into which the food item 144 is to be divided, number of blades desirably used, the length and angled disposition of the blades 104, 106, and 108, and so on. Accordingly, the shape or angle at which the blades 104, 106, and 108 curve may vary, and may further vary along the length of each, but may desirably be such that blades 104, 106, and 108 simultaneously engage the surface or food to be cut during substantially the entirety of the rolling rotation of the slicer 100 across the food in preferably a single pass, although more than one cutting pass may be required in practice.

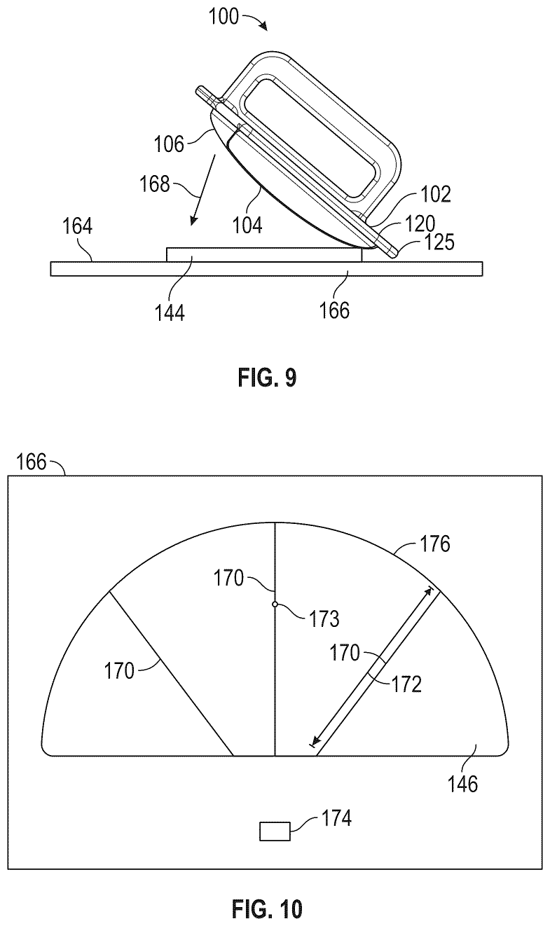

FIG. 9 is a side view illustrating the slicer 100 positioned for operation. The food item 144 is shown positioned on a top surface 164 of a work space 166, such as cutting board, table, or other food preparation space. In this embodiment, the tab 125 is shown engaging the top surface 164 of the work space 166. Given the overall dimensions of the slicer 100, and more particularly, the blades 104, 106, and 108, the tab 125 may be sized to extend from the back 120 of the frame 102 to angularly position the slicer 100 in a ready position, as shown, so that the blades 104, 106, and 108 are located above the food item 144 when the tab 125 engages the top surface 164. The slicer 100 may then be rotated from the back 120 to the front 118 by the user in a generally downward arcing direction or motion as shown by arrow 168. As the slicer 100 is rotated from the back 120 to the front 118, the blades 104, 106, and 108 engage and cut the food item 144 into portions 146.

FIG. 10 illustrates a top view of one embodiment of the work space 166 configured to complement the slicer 100. In this embodiment, the work space 166 may be configured with a plurality of guides 170. Each of the plurality of guides 170 is recessed to form grooves or channels in the top surface 164 of the work space 166 extending a length 172 across the work space 166. The location, disposition, and lengths of the guides 170 correspond to the relative location, disposition, and lengths of the blades 104, 106, and 108 of the slicer 100 during operation. For example, in this embodiment, the angular disposition of the guides 170 correspond to the angular disposition of the blades 104, 106, and 108. Further, the depths into which guides 170 recess into the top surface 164 of work space 166 cutting surface may be consistent throughout the length 172 of the guides 170, in one embodiment. While in other embodiments, the depths of the guides 170 may vary along the length 172 of the guides 170, for example, gradually deepening toward a mid-point 173 along the length 172 of the guides 170 and then shallowing, for example, to correspond to the angled disposition of the lower edges 132, 134, 136 of the blades 104, 106, 108.

The work space 166, in this embodiment, may also include a set marker 174 which may be a groove, mark, or indicia on the work space 166. The set marker 174 may be used as an identifier to assist the user in positioning the slicer 100 before cutting the food item 144. Specifically, the set marker 174 may indicate the location where the tab 125 of the slicer 100 should be placed on the work space 166 to properly distance and align the slicer 100 before cutting the food item 144. As the slicer 100 is operated, in this embodiment of the work space 166, and as the blades 104, 106, and 108 cut through the food item 144, the blades 104, 106, and 108 extend into the respective guides 170. In some embodiments, the set marker 174 and/or guides 170 may provide for improved positioning of the slicer, improved cutting or sectioning of the food item 144 into the portions 146 and allow the user to sense or feel the proper positioning as the blades 104, 106, and 108 are received into the guides 170. Further, the guides 170 may allow for the blades 104, 106, and 108 to travel through the food item 144 being cut to beyond or below the cutting surface to ensure complete cut through the food item 144. While the guides 170 are discussed as recessed in this embodiment, other embodiments contemplate guides 170 that may be configured as one or more raised rails similarly positioned to assist in guiding the blades 104, 106, and 108.

The work space 166 may also include a food marker 176 used to indicate the proper location of the food item 144 before cutting. The food marker 176 may be a groove, raised portion, mark, or indicia on the work space 166 that generally conforms to the outline of the food item 144. Thus, in this embodiment, the food marker 176 is semicircular since the food item 144 described in the present embodiment is generally semicircular. However, the food marker 176 may be any shape, outline, or indicia that may be used to assist the user in identifying the proper location of the food item 144 before cutting. As will be appreciated, location and spacing of the food marker 176 and set marker 174 on the work space 166 correspond to the overall shape of the food to be cut, associated size of the slicer 100, and location of the tab 125 when the slicer 100 is placed in the ‘ready position,’ as generally shown in FIG. 9.

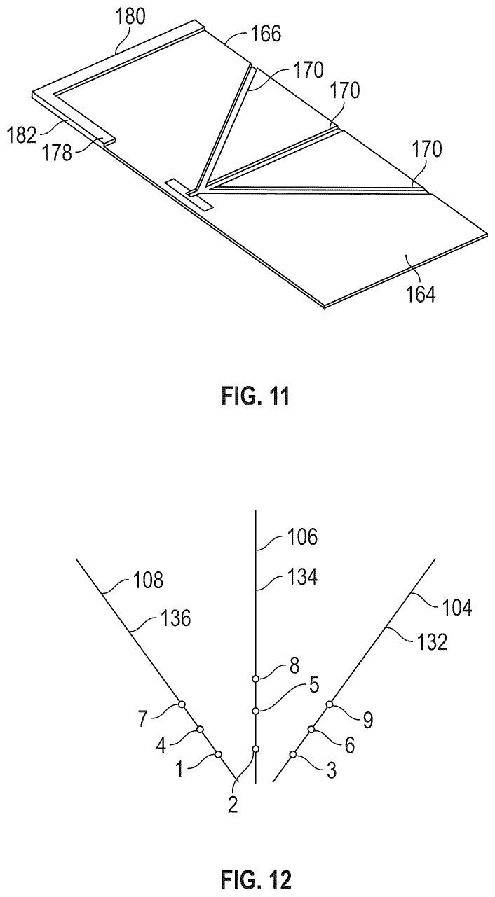

FIG. 11 is another embodiment of the work space 166 having the plurality of guides 170 or channels (e.g., grooves, depressions, indentations, etc.) that match or substantially match or correspond to the locations and angles of the blades 104, 106, and 108. In this embodiment, the work space 166 also includes a guide bracket 178 extending along a first side 180 and at least part of a second side 182 of the work space 166. The guide bracket 178 may be raised sufficiently, extending above the top surface 164 of the work space 166, to receive a portion of the food item 144 for proper positioning and alignment (e.g., a projection, etc.). The work space 166 and guide bracket 178 may be sized and configured such that the food item 144 may be aligned in the proper position using the guide bracket 178 before cutting the food item 144. While the guide bracket 178 is shown extending entirely along the first side 180 and extending partially long the second side 182, in other embodiments the guide bracket 178 may extend different distances and be located on fewer or more sides of the work space 166 in addition to or instead of just the first and second sides 180 and 182. Although the guide bracket 178 is raised in the present embodiment, in other embodiments, the guide bracket 178 may merely be indicia on the top surface 164 and used for such purposes.

In some embodiments, it may be useful to place the food item 144 in a bag, sack, or other packaging, prior to cutting. In such case, it may be difficult for the user to see the food item 144 within the package and properly align the food item 144 for cutting. In cases where the food item is semicircular, the packaging may be substantially rectangular, although other shapes and sizes of packaging are contemplated depending on the type of food item 144 to be cut. In this case, the rectangular packaging, with the food item 144 inside, may be placed on the work space 166 and aligned using the guide bracket 178 for cutting the food item 144 inside the packaging.

In operation, the food item 144 is placed on the work space 166, which may be a cutting board, table, or any other food preparation space or surface. The user engages the slicer 100, such as via the handle 110, and positions the slicer 100 such that the tab 125 contacts the top surface 164 of the work space 166 adjacent the food item 144. In some embodiments, the user may use the set marker 174 and food marker 176 to position the food item 144 and slicer 100. The user then manipulates the slicer 100 by pressing the slicer 100 downward toward the work space 166 from the back 120 to the front 118 in a rotating or forward rolling or arcing movement to cause the blades 104, 106, and 108 to traverse and cut or separate the food item 144 into the portions 146. The curved lower edges 132, 134, and 136 of blades 104, 106, and 108 promote the rotational or rolling movement of the slicer 100. To ensure a complete cut or separation of the portions 146, the steps may be reversed and repeated as necessary. For example, the slicer 100 may then be rolled or rocked from the front 118 to the back 120, and so on until the food item 144 is sufficiently sectioned into the portions 146.

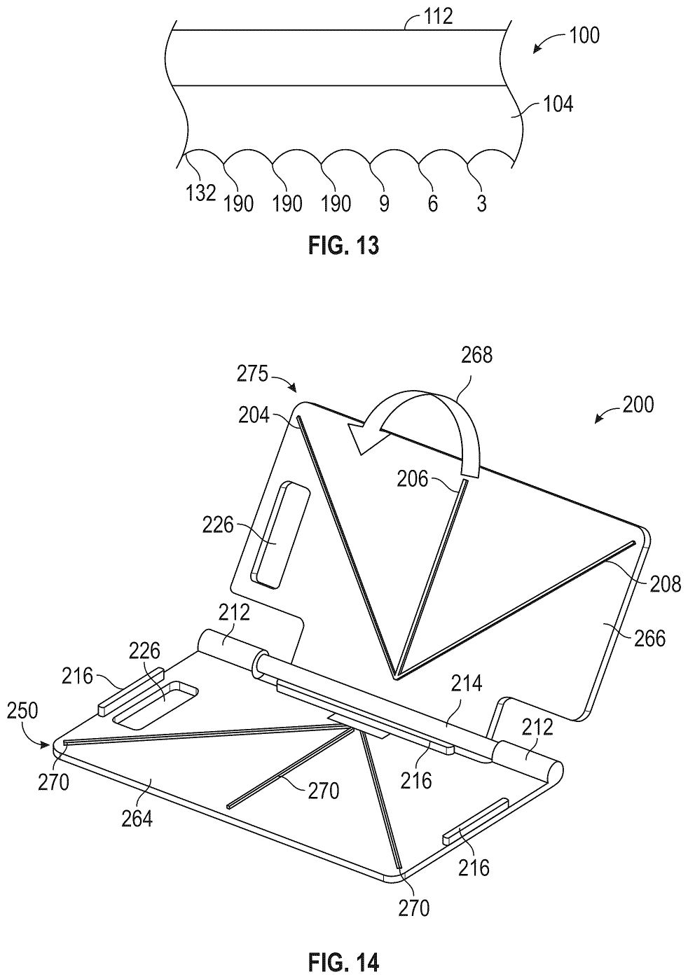

While in some embodiments, the curved lower edges 132, 134, and 136 of the blades 104, 106, and 108 may be generally uniform curved straight cutting edges along the length, in other embodiments, the curved lower edges 132, 134, and 136 of the blades 104, 106, and 108 may have non-linear cutting edges such as a scalloped pattern or serrations (referred to as “serrations” in the following text). FIG. 12 illustrates exemplary locations of serrations along the length of the curved lower edges 132, 134, and 136 of blades 104, 106, and 108 according to another embodiment. Referring also to FIG. 13, a partial side cut-away of the slicer 100 is shown with blade 104 with serrations 190 provided on the curved lower edge 132 of blade 104. The serrations along the length of the curved lower edges 132, 134, and 136 of blades 104, 106, and 108 may allow for a complete cut through the food item 144. In the embodiments shown in FIGS. 12 and 13, the serrations 190 include serration high points identified as numbers 1-9 (exaggerated in spacing for illustration), are staggered and provide “high points” of the serrations 190 along the length of the curved lower edges 132, 134, and 136 such that as rolling force is applied, the majority of force is concentrated on a single blade serration high point 1-9 which moves to the adjacent blade as the cutter continues its motion.

For example, a first set of serration high points 1-3 are provided on the curved lower edges 132, 134, and 136 of blades 104, 106, and 108 and correspond positionally such that serration high points 1, 2 and 3 engage the surface or the food item 144 in that order at sequentially different times as the slicer 100 is rotated to cut the food item 144, thus concentrating force at each point in sequence. Similarly, second and third sets of serration high points 4-6 and 7-9 are provided. The second set of serration high points 4-6 similarly correspond positionally to one another and engage the surface or the food item 144 in that order, 4, then 5, then 6, at sequentially different times as the slicer 100 is rotated to cut the food item 144, as do serration high points 7-9. Each of the first, second, and third sets of serration high points 1-3, 4-6, and 7-9 are provided at different points along the curved lower edges 132, 134, and 136. While only three (3) sets of serrations are show, more or fewer, closer or further spaced apart, and located at varying points along the curved lower edges 132, 134, and 136, may be provided, as will be understood by one skilled in the art in light of the present disclosure. The size of the serrations may vary and depending on the type, such as size and depth, of the food item 144 to be cut. In this manner, the cutting force may be concentrated on one point of the corresponding set of serrations at a time as the blades 104, 106, and 108 are rotated and the cutting force is applied along the length of the food item 144. In this manner, the corresponding force concentration changes as the blades 104, 106, and 108 rotate to cut the food item 144.

It is contemplated that, while the serrations 190 shown in FIG. 13 are more pointed, the serrations 190 maybe more rounded or otherwise configured in other embodiments. Further, while the curved lower edge 132 of the blade 104 shown in FIG. 13 may appears flat or straight, in the present embodiment, it is contemplated that the curved lower edges 132, 134, and 136 of the blades 104, 106, and 108, are curved along the length of the of blades 104, 106, and 108.

In other embodiment, the serrations 190 may be positioned such that the first, second, and third sets of serration high points 1-9 engage the surface or food item at substantially the same time, instead of different times, as discussed above. For example, serration high points 1, 2 and 3 may be positionally located to engage the surface or food item 144 at substantially the same time as the slicer 100 is rotated to cut the food item 144. The second and third sets of serration high points 4-6 and 7-9 may be similarly provided.

While in some embodiments, it may be desirable for the blades 104, 106, and 108 to be constructed of metal and the frame 102 and handle 110 be constructed of polymeric materials, the various components described herein that comprise the slicer 100 may be constructed of metal, such as stainless steel, plastic or polymeric materials, or any other materials or various combinations thereof. It is noteworthy, that while the present disclosure may be employed in any kitchen, commercial kitchens may also benefit from teachings herein.

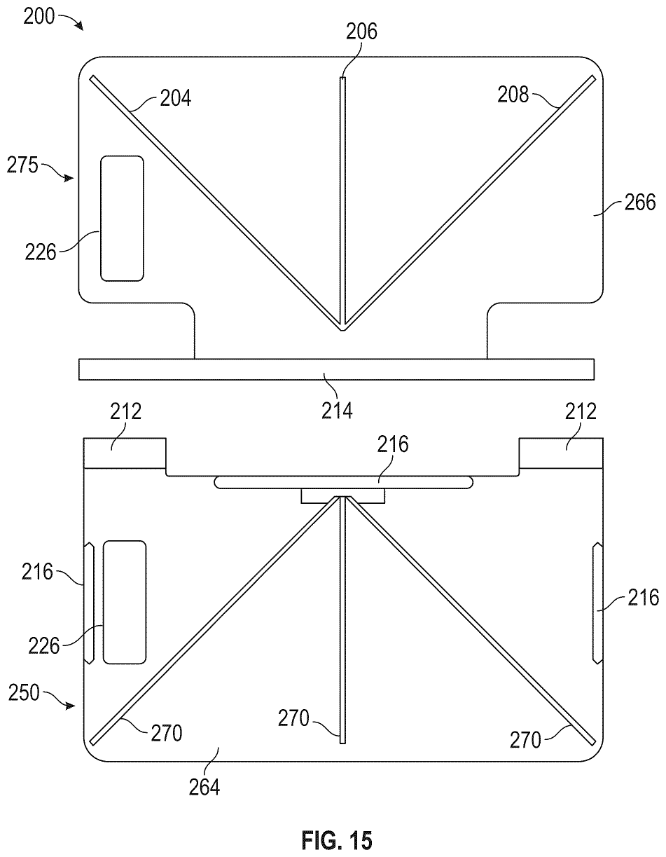

FIGS. 14-16 show another embodiment of a multi-blade food slicer, shown as slicer 200. The slicer 200 is shown to include a top portion 275 that is coupled to a bottom portion 250. In exemplary embodiments, the top portion 275 is rotatably coupled to the bottom portion 250 via an attachment mechanism. As shown in FIGS. 14 and 15, the attachment mechanism represents a hinge connection. The hinge connection is shown to include a hinge shaft 214 and hinge sockets 212, whereby the hinge shaft 214 is at least partly received by the hinge sockets 212.

In this embodiment, the top portion 275 is shown to include three (3) blades 204, 206, and 208 which are used to slice a food product. However, more or fewer blades 204, 206, and 208 may be used depending on the number of sections or portions into which the food product is to be divided. The blades 204, 206, and 208, which may also be referred to as center blade 206 and outer blades 204 and 208, are coupled to and extend from a lower side 266 of the top portion 275. In some embodiments, the blades 204, 206, and 208 may be integral with the top portion 275 (e.g., a unitary piece). The blades 204, 206, and 208 extend down, generally perpendicular to the lower side 266 of top portion 275. In the example shown, the blades 204, 206, and 208 are elongated cutting blades or cutting devices. The blades 204, 206, and 208 converge near the hinge shaft 214, such that the blades are arranged in a relatively triangular pattern. In other embodiments, the blades may be arranged in a different manner, such as being parallel oriented (e.g., three blades parallel oriented), in a plus (+) shape, and/or in various other desired patterns.

The bottom portion 250 is configured to complement or substantially complement the top portion 275, in that the bottom portion 250, or portion thereof, is a mirror image of the top portion 275 that includes features that mate or engage with each other when the top portion 275 is in the closed position (i.e., proximate the bottom portion 250).

The bottom portion 250 is shown to include a plurality of guides 270. Each of the plurality of guides 270 is recessed to form grooves or channels in the top surface 264 of the bottom portion 250. In the example shown, the location, disposition, and lengths of the guides 270 correspond to the relative location, disposition, and lengths of the blades 204, 206, and 208 of the slicer 200 during operation. For example, in this embodiment, the angular disposition of the guides 270 correspond to the angular disposition of the blades 204, 206, and 208. In this way, the guides 270 converge near the hinge sockets 212, such that the guides 270 form a relatively triangular pattern. Further, the depths into which guides 270 recess into the top surface 264 of the bottom portion 250 may be consistent throughout the length of the guides 270, in some embodiments. In other embodiments, the depths of the guides 270 may vary along the length of the guides 270, for example, gradually deepening toward a mid-point along the length of the guides 270 and then shallowing, for example, to accommodate curves along the cutting edge of the blades 204, 206, 208. Similarly, the widths of the grooves or channels (guides 270) may be consistent along the length of the guides 270 or vary along the length in other embodiments. Further, the depicted widths may be only slightly larger than the width of the received blade (e.g., 1/16^{th} inch wider). In this way, a rather snug or close fit is provided to avoid food and other objects that are cut from falling within the grooves (guides 270).

As shown, the top portion 275 includes a hinge shaft 214 that extends from an edge of the top portion 275. The hinge shaft 214 is configured to engage with the hinge sockets 212 to form the attachment mechanism shown in FIG. 14. The hinge shaft 214 is shown to be generally cylindrical in shape. But, in other embodiments, a different shape may be utilized. As shown in FIG. 15, a single hinge shaft 214 extends along an entire length of the top portion 275. However, in other embodiments, multiple hinge shafts 214 (e.g., 2, 3, 4, etc.) may extend from an edge of the top portion 275. Additionally, a single hinge shaft 214 may extend along a portion of the length of the top portion 275 rather than extending along the entire length. The position of the hinge sockets 212 along the edge of the bottom portion 250 may vary to accommodate the position and size of the hinge shaft(s) 214. All such variations are intended to fall within the spirit and scope of the present disclosure.

While the guides 270 are discussed as recessed in this embodiment, other embodiments contemplate guides 270 that may be configured as one or more raised rails similarly positioned to assist in guiding the blades 204, 206, and 208. In this embodiment, the top portion 275 may define corresponding channels or grooves that receive the raised rails or projects and enable the top portion 275 to close and be proximate to the bottom portion 250. In the close position and in the example shown, a major plane associated with the top portion 275 may be parallel or substantially parallel to a major plane associated with the bottom portion 250.

In still other embodiments, the guides 270 may be holes or openings that receive at least part of the respective blade 204, 206, and/or 208. In the example shown, the guides 270 have a bottom surface that may interface or engage with at least part of a received blade. Beneficially, this structure may shield the blade when the top portion 275 is in the closed position and proximate the bottom portion 250. In yet further embodiments, the guides 270 may include a sharpening and/or cleaning mechanism. In this way, when the blades are received by the guides, the sharpening and/or cleaning mechanism may sharpen and/or clean the blades thereby helping with longevity of the blades.

The bottom portion 250 is shown to include three (3) spacers 216 positioned along a perimeter of the bottom portion 250. In the example shown, a first/central spacer 216 is positioned between the hinge sockets 212, while a second and a third spacer 216 (i.e., the outer spacers) are positioned on the adjacent edges. In this example, the edge opposite the hinge sockets 212 does not include a spacer 216. In this way, the slicer 200 may accommodate food or other items of various lengths. The spacers 216 are shown to extend upwards, generally perpendicular to the top surface 264 of the bottom portion 250. Advantageously, the spacers 216 may be used to align a food item before cutting. For example, a flat edge of a semicircular quesadilla may be positioned against the central spacer 216 located between the hinge sockets 212 and the outer spacers 216 on the adjacent edges.

The bottom portion 250 is shown to include hinge sockets 212 positioned along an edge of the bottom portion 250. To assemble the slicer 200, a user may insert the ends of the hinge shaft 214 into the hinge sockets 212. Once coupled, the hinge shaft 214 may rotate within the hinge sockets 212. In this way, the top portion 275 may rotate relative to the bottom portion 250, as shown by arrow 268, when the bottom portion 250 is restrained from rotation, such as resting on a surface (e.g., a tabletop). If the bottom portion 250 is not restrained from rotation, the top and bottom portions 275 and 250, respectively, may each rotate about an axis defined by the hinge shafts 214 (particularly, a central axis extending longitudinally through the hinge shafts 214). In operation, a user may position a food item on the bottom portion 250 and may then rotate the top portion 275 towards the bottom portion 250. By pressing down on the top portion 275, the user drives the blades 204, 206, and 208 through the food item, and engaging the blades 204, 206, and 208 with the guides 270. This action slices the food item into portions that match the angular arrangement of the blades 204, 206, and 208.

The spacers 216 define a height H that is a portion of the height of the blades 204, 206, 208. For example, the spacers 216 may be 50-75% of the blades 204, 206, 208. In this way, the blades extend past the spacers 216 during the cutting process, such that the food items are sliced fully or substantially fully through without interference from the spacers. Advantageously, the spacers 216 absorb at least some of the downward pressure exerted on the slicer 200 when in use. This reduces wear on the blades 204, 206, and 208, as well as the guides 270, thereby mitigating blade deformation and damage to the guides 270.

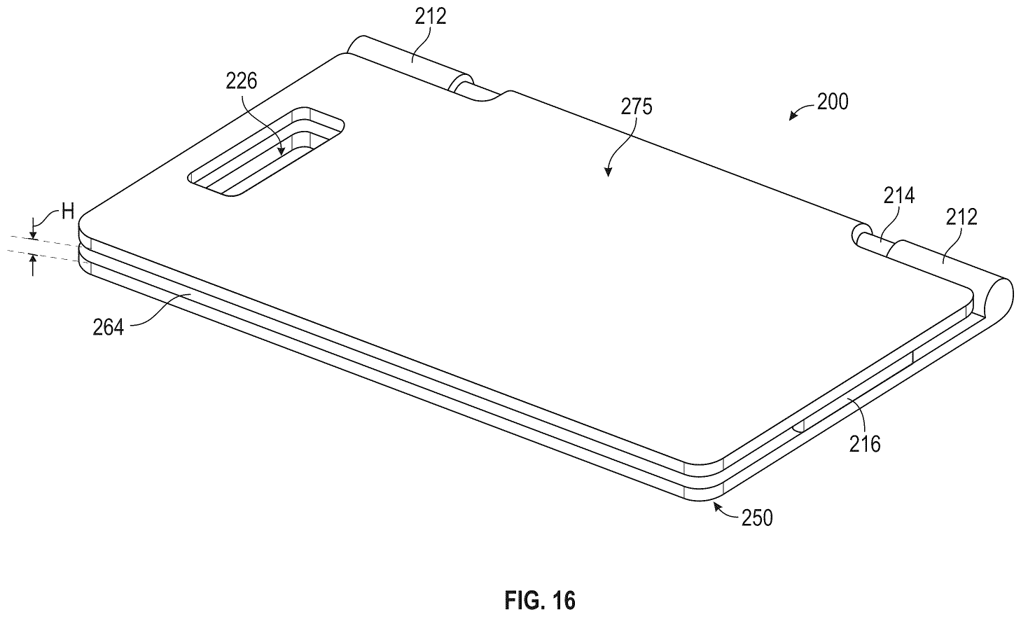

The top portion 275 and the bottom portion 250 are shown to include openings 226. As shown in FIG. 16, upon rotating the top portion 275 to align the top portion 275 with the bottom portion 250, the openings 226 are aligned to form one continuous opening. The openings 226 may be used to hang the slicer 200 for storage when not in use. By hooking through the aligned openings 226 for storage, the slicer maintains a closed position in which the blades 204, 206, 208 of the top portion 275 rest against the guides 270 of the bottom portion 250. Advantageously, this storage position reduces the risk of accidental contact with the blades 204, 206, and 208 when the slicer 200 is not in use. Further, the aligned openings 226 may serve as a handle for a user to carry and transport the slicer or cutting slicer 200. Beneficially, when slicer or cutting slicer 200 is in the closed position (top portion 275 is positioned a closest distance to the bottom portion 250 given the spacers), the openings 226 are aligned to enable a user to engage with both portions at once and transport the slicer 200 while the closed position shields or covers the blades from exposure. This reduces the chance that a user may inadvertently engage with a blade while moving or carrying the slicer 200.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the description may describe a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A multi-blade food slicer, comprising:
a frame having an upper side, a lower side, a front, and a back; and
a plurality of blades coupled to the lower side of the frame, comprising:
a first blade extending along a portion of the frame from at or near the front to the back,
a second blade angularly disposed relative to the first blade and extending along the frame from at or near the front to the back on or near a left side of the frame, and
a third blade angularly disposed relative to the first blade and extending along the frame from at or near the front to the back on or near a right side of the frame.

2. The multi-blade food slicer of claim 1, further comprising a handle coupled to the upper side of the frame.

3. The multi-blade food slicer of claim 1, wherein each of the plurality of blades have a curved lower side, and wherein a curved shape of the first blade is different than a curved shape of the second blade and the third blade, such that the first blade, the second blade, and the third blade maintain substantially continuous contact with a cutting surface when rotationally operated.

4. The multi-blade food slicer of claim 3, wherein the curved shape of the second blade and the third blade are substantially the same.

5. The multi-blade food slicer of claim 1, wherein each of the plurality of blades has a length defined as a distance that each blade of the plurality of blades extends from the at or near the front to the back of the lower side of the frame, and wherein the length of the second blade and the third blade is different than the length of the first blade.

6. The multi-blade food slicer of claim 5, wherein the length of the first blade is greater than the length of either of the second blade or the third blade.

7. The multi-blade food slicer of claim 6, wherein the length of the second blade and the third blade is approximately equal.

8. The multi-blade food slicer of claim 1, further comprising a tab extending from a back of the frame.

9. The multi-blade food slicer of claim 1, further comprising a front extension extending from a front of the frame, wherein the front extension defines an opening extending through the front extension.

10. A multi-blade food slicer, comprising:
a frame having an upper side, a lower side, a front, and a back, the frame having:
a first arm extending along a middle of the frame from at or near the front to the back of the frame,
a second arm angularly disposed relative to the first arm and extending from at or near the front to the back on or near a left side of the frame, and
a third arm angularly disposed relative to the first arm and extending from at or near the front to the back on a right side of the frame;
a plurality of blades, comprising:
a first blade coupled to the first arm on the lower side of the frame and extending from at or near the front to the back,
a second blade coupled to the second arm on the lower side of the frame and extending from at or near the front to the back, and
a third blade coupled to the third arm on the lower side of the frame and extending from at or near the front to the back;
a cross-member extending across the front of the frame and connected to the first arm, the second arm, and the third arm; and
a handle coupled to the upper side of the frame on the first arm.

11. The multi-blade food slicer of claim 10, wherein back ends of the first arm, the second arm, and the third arm form the back of the frame.

12. The multi-blade food slicer of claim 11, further comprising a tab extending from a location on the back of the frame formed by the back ends of the first arm, the second arm, and the third arm.

13. The multi-blade food slicer of claim 10, wherein the second blade is offset from the first blade and extends along the second arm at an angle of between approximately 25 to 45 degrees, and wherein the third blade is offset from the first blade and extends along the third arm at an angle of between approximately 25 to 45 degrees.

14. The multi-blade food slicer of claim 10, wherein each of the plurality of blades has a curved lower side, and wherein a curved shape of the first blade is different than a curved shape of the second blade and the third blade, such that the first blade, the second blade, and the third blade maintain substantially continuous contact with a cutting surface when rotationally operated.

15. The multi-blade food slicer of claim 14, wherein the curved shape of the second blade and the third blade are substantially the same.

16. The multi-blade food slicer of claim 10, wherein each of the plurality of blades have a length defined as a distance each of the plurality of blades extends from at or near the front and back of the lower side of the frame, and wherein the length of the second blade and the third blade is different than the length of the first blade.

17. The multi-blade food slicer of claim 16, wherein the length of the first blade is greater than the length of the second blade and the third blade, and wherein the length of the second blade and the third blade is approximately equal.

18. The multi-blade food slicer of claim 10, further comprising a front extension extending from the front of the frame, wherein the front extension defines an opening extending through the front extension.

19. A multi-blade food slicer, comprising:
a top portion having:
a first blade; and
a second blade angularly disposed relative to the first blade; and
a bottom portion rotatably coupled to the top portion, wherein the top portion is movable from a closed position to an open position whereby the top portion is positioned a relatively greater distance away from the bottom portion in the open position than in the closed position, wherein the bottom portion includes:
a first recessed guide structured to at least partly receive the first blade when the top portion and the bottom portion are in the closed position; and
a second recessed guide angularly disposed relative to the first recessed guide, the second recessed guide structured to at least partly receive the second blade when the top portion and the bottom portion are in the closed position.

20. The multi-blade food slicer of claim 19, wherein the bottom portion includes at least one spacer positioned at or near a perimeter of the bottom portion, and wherein the at least one spacer extends extend away from the bottom portion and toward the top portion when the top portion and the bottom portion are in the closed position.
